(19) United States
(12) Patent Application Publication
(10) Pub. No.: US 2009/0096637 A1
(43) Pub. Date: Apr. 16, 2009

(54) Distributed Mine Management System

(75) Inventors: Jonathan P. Olson, Tucson, AZ (US); Marco Antonio Villarreal Antelo, Tucson, AZ (US); James William White, Tucson, AZ (US); Robert Arthur Wilson, JR., Tucson, AZ (US)

Correspondence Address: QUARLES & BRADY LLP, ONE SOUTH CHURCH AVENUE, SUITE 1700, TUCSON, AZ, 85701-1621, US

(73) Assignee: MODULAR MINING SYSTEMS, INC., Tucson, AZ (US)

(21) Appl. No.: 12/132,168

(22) Filed: Jun. 3, 2008

Related U.S. Application Data
(63) Continuation-in-part of application No. 11/608,681, filed on Dec. 8, 2006.
(60) Provisional application No. 60/749,218, filed on Dec. 9, 2005.

(51) Int. Cl. G08G 1/123

(52) U.S. Cl. 340/993

(57) ABSTRACT

A distributed mine management system contains a central computer having a first database controlled by a first controller. At least one mobile computer is in communication with a piece of mobile equipment. Each of the mobile computers has a second database controlled by a second controller. The mobile computers store high, medium and low priority data about the status of the mobile equipment in the second database according to the priority of the information. The mine management system includes a remote worksite computer and an intermittent communication path between the remote worksite computer and the central computer. A wireless communication network enables communication between the first controller and the second controller, wherein said mobile computer is operable independent of the first logic unit.

### RELATED APPLICATIONS

This application is a continuation-in-part application of application Ser. No. 11/608,681, filed Dec. 8, 2006, which was based on provisional application No. 60/749,218 filed Dec. 9, 2005.

### FIELD OF THE INVENTION

The invention relates to systems and methods for managing the movement of vehicles, material and information in a mining environment.

### BACKGROUND OF THE INVENTION

In the early 1980s, Modular Mining Systems, Inc. introduced DISPATCH®, an integrated system for managing the movement of vehicles in open pit and underground mining environments. DISPATCH® originally relied on a central Virtual Address Extension (“VAX”) machine in communication with mobile field units located on mobile pieces of mining equipment such as trucks and shovels. Communication between the central computer and the mobile field units was accomplished over a 9600 baud (bits-per-second) connection with a serial port on the VAX machine. The field units that were originally part of DISPATCH® had limited functionality, essentially being able to receive only rudimentary text and graphical information and being able to send only information relating to button pushing in the field unit. Communication between the field units and the central VAX machine was accomplished through wireless data communication technology available at the time, which included narrow band UHF or VHF communications. The peak data transmission rate achievable with such systems was in the 1200 to 9600 baud range.

In addition to being limited by the available wireless data transmission technology, early mine management systems were limited by the unavailability of computing power in the field units. When DISPATCH® was first introduced, computing power and data storage were at a premium. Accordingly, the field units had little computing capability and functioned only to collect data about the field unit and forward that data to the central VAX machine. Computer memory was also expensive and bulky, and, accordingly, mobile field units stored just enough data to support their data forwarding function. In early DISPATCH® systems, almost all computing and data storage functions were provided on the central VAX machine and mobile access to the stored central data was available only through the processes run on the central VAX machine.

Early DISPATCH® systems were also limited by the ability of early processors to only run one process at a time. In early VAX implementations, the only viable means of sharing data among multiple processes was through the use of shared, memory mapped files. Interprocess communication under VMS, the operating system for VAX machines, was primitive, supporting only event flags that initiated other processes in series.

The fact that data storage and processing were centralized on a central server required nearly 100% network availability. If the wireless network in early systems went down, field units would be cut off from centrally stored data and processes, such as vehicle routing information. Moreover, even with 100% network availability, problems would occur when field units moved into areas not covered by the early wireless networks.

### SUMMARY OF THE INVENTION

Embodiments of the invention relate to a systems, methods and computer program products for tracking the movement of mobile equipment in a mine environment. Systems according to embodiments of the invention contain a central computer having a first database controlled by a first controller. At least one mobile computer is in communication with a piece of mobile equipment. At least one remote worksite is in communication with the central computer via an intermittent data communication path. Each of the mobile computers has a second database controlled by a second controller. A wireless communication network enables communication between the first controller and the second controller, wherein said mobile computer is operable independent of the first logic unit. The mobile computer tracks and stores data regarding the status of the mobile equipment, identifies high, medium and low priority information regarding the status of the mobile equipment, and stores the high, medium and low priority information regarding the status of the mobile equipment. Data stored by the mobile computer is synchronized with the first database according to its priority.

### BRIEF DESCRIPTION OF THE DRAWINGS

FIG. 1 is a schematic diagram of a distributed mine management system according to an embodiment of the invention.

FIG. 2 is a block diagram of the computing and communication components of a distributed mine management system according to an embodiment of the invention.

FIG. 3 is a block diagram showing the components of a general purpose computer according to an embodiment of the invention.

FIG. 4 is a front view of a mobile electronic device used in a distributed mine production system according to an embodiment of the invention.

### DETAILED DESCRIPTION OF THE PREFERRED EMBODIMENTS

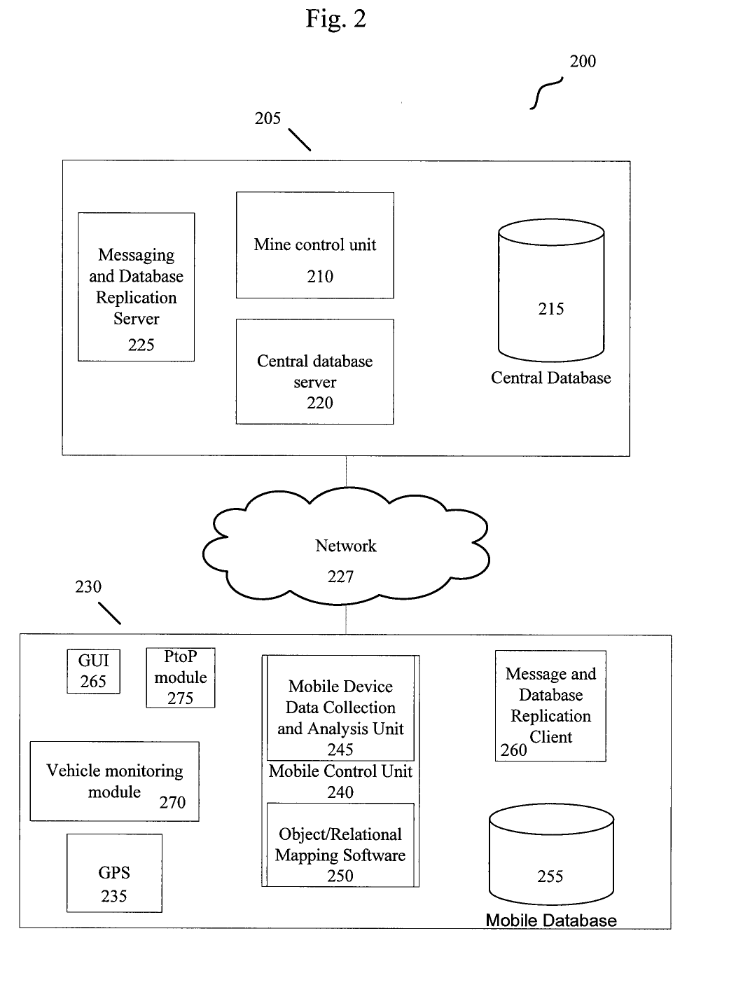

Many of the functional units described in this specification have been labeled as modules or units (e.g., elements 210, 240, 245, 270, 275, FIG. 2) in order to more particularly emphasize their implementation independence. For example, modules and/or units (e.g., elements 210, 240, 245, 270, 275, FIG. 2) may be implemented as a hardware circuit comprising custom VLSI circuits or gate arrays, off-the-shelf semiconductors such as logic chips, transistors, or other discrete components. A module and/or unit (e.g., elements 210, 240, 245, 270, 275, FIG. 2) may also be implemented in programmable hardware devices such as field programmable gate arrays, programmable array logic, programmable logic devices, or the like.

Modules and/or units (e.g., elements 210, 240, 245, 270, 275, FIG. 2) may also be implemented in software for execution by various types of programmable processors. These modules and/or units may be referred to simply as “logic.” An identified module or unit of executable code may, for instance, comprise one or more physical or logical blocks of computer instructions which may, for instance, be organized as an object, procedure, or function. Nevertheless, the executables of an identified module and/or unit (e.g., elements 210, 240, 245, 270, 275, FIG. 2) need not be physically located together, but may comprise disparate instructions stored in different locations which, when joined logically together, comprise the module and achieve the stated purpose for the module.

Indeed, a module and/or unit of executable code (e.g., elements 210, 240, 245, 270, 275, FIG. 2) may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a signal bearing medium may take any form capable of generating a signal, causing a signal to be generated, or causing execution of a program of machine-readable instructions on a digital processing apparatus. A signal bearing medium may be embodied by a transmission line, a compact disk, digital-video disk, a magnetic tape, a Bernoulli drive, a magnetic disk, a punch card, flash memory, integrated circuits, or other digital processing apparatus memory device.

Any schematic flow chart diagrams included are generally set forth as logical flow-chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow-chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The described operations may be implemented as a method, apparatus or article of manufacture, including a computer program product, using standard programming and/or engineering techniques to produce software, firmware, hardware, or any combination thereof. The described operations may be implemented as code maintained in a “computer readable medium,” where a processor may read and execute the code from the computer readable medium.

A computer readable medium may comprise media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. The code implementing the described operations may further be implemented in hardware logic implemented in a hardware device (e.g., an integrated circuit chip, Programmable Gate Array (PGA), Application Specific Integrated Circuit (ASIC), etc.). Still further, the code implementing the described operations may be implemented in “transmission signals,” where transmission signals may propagate through space or through a transmission media, such as an optical fiber, copper wire, etc.

The transmission signals in which code, logic or data is encoded may further comprise a wireless signal, satellite transmission, radio waves, infrared or other optical signals, Bluetooth, etc. The transmission signals in which code, logic or data is encoded is capable of being transmitted by a transmitting station and received by a receiving station, where the code, logic or data encoded in the transmission signal may be decoded and stored in hardware or a computer readable medium at the receiving and transmitting stations or devices.

An “article of manufacture,” including a computer program product, comprises computer readable medium, hardware logic, and/or transmission signals in which code may be implemented. A device in which the code implementing the described embodiments of operations is encoded may comprise a computer readable medium or hardware logic. Of course, those skilled in the art will recognize that many modifications may be made to this configuration without departing from the scope of the present invention, and that the article of manufacture may comprise suitable information bearing medium known in the art.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

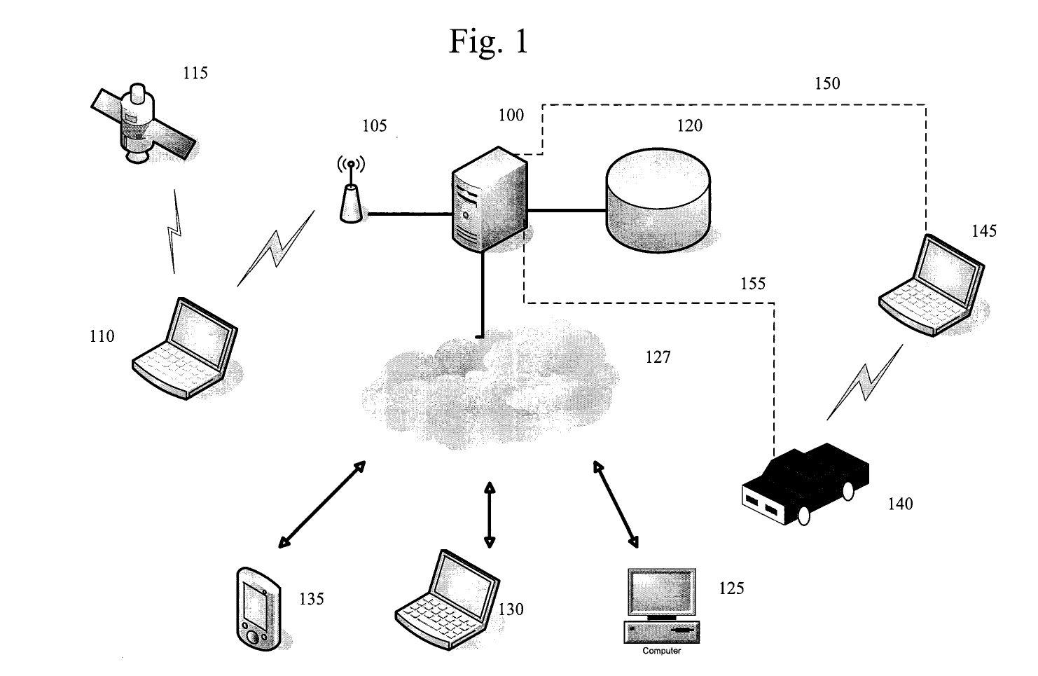

FIG. 1 shows a distributed mine management system according to an embodiment of the invention. A mine management system according to the invention is used to collect data concerning the operation of vehicles and mining equipment and track and optimize the movement of material and equipment throughout a mining environment. A mine management system according to an embodiment of the invention includes a central computer unit 100. The central computer unit 100 includes one or more individual computers. The mine management system also includes a database 120 in communication with the central computer unit 100. The database 120 is optionally configured to be accessible through any available Structured Query Language (“SQL”) type database management language. The central computer unit 100 is in communication with one or more wireless transceivers 105. Wireless transceiver 105 is optionally an internet protocol based wireless transceiver operating under one of the IEEE 802.11 standards.

The wireless transceiver 105 is in wireless communication with a mobile computer 110. The wireless communication link between the wireless transceiver 105 and the mobile computer 110 is optionally a signal operating in accordance with one of the IEEE 802.11 standards. Other data communication links between mobile computer 110 and central computer 100 are acceptable. For example, central computer 100 and mobile computer 110 can communicate via any combination of conducted electrical, radio frequency or optical data signals conveyed in any appropriate signal bearing medium.

The mobile computer 110 is in communication with a mobile piece of mining equipment, for example, a mining truck. In some embodiments, the mobile computer 110 is physically joined to the mobile piece of mining equipment. The mobile computer 110 receives data from a plurality of Global Position System (GPS) satellites 115, and, on the basis of such data, calculates the position, heading and speed of the piece of mining equipment. Alternatively, or additionally, the mobile computer 110 collects time varying position data on the basis of the GPS data, forwards the time varying position data to the central computer 100, and receives calculated velocity and position data from the central computer 100. The mobile computer 110 also optionally communicates with a plurality of on-board sensors that collect other data about the piece of mobile equipment. For example, the mobile computer 110 may collect data from sensors that detect oil pressure, levels and temperature, engine temperature, tire pressure, weight, and the status and/or position of the bed, in the event that the piece of mobile equipment is a mining truck. Additionally or optionally, mobile computer 110 is in communication with on-board proximity sensors that detect proximity to other vehicles or stationary equipment. Mobile computer 110 may optionally store information collected from on-board sensors and/or GPS satellites, perform calculations on the basis of stored information and/or forward collected and/or stored information to the central computing unit 100.

Embodiments of a distributed mine management system according to the invention include a remote worksite computer 145. The remote worksite computer 145 is a computer at a worksite that does not have continuous data communication with central computer 100. Remote worksites may be located outside the range or the line of sight of wireless transceiver 105. For example, a remote worksite computer 145 may be located at a drill that is stationed far from a mine site that includes an operational network. In the case where a distributed mine management system includes a wireless network comprising multiple wireless transceivers 105, an area may also be defined as a remote worksite when a portion of the wireless network becomes inoperable, putting the remote worksite computer 145 out of contact with the network. Remote worksite computer 145 is operable to gather status information from and relay data to equipment located at the remote work site in the same manner as mobile computer 110 gathers data from and passes data to mobile mine equipment.

Embodiments of a distributed mine management system according to the invention include an intermittent communication path 150 that provides intermittent data communication between remote worksite computer 145 and central computer 100. Intermittent communication path 150 allows periodic updates to be exchanged between remote worksite computer 145 and central computer 100 when the intermittent communication path 150 is established. Intermittent communication path 150 may be implemented as a non-volatile storage device, such as a solid state memory card, that an equipment operator at a remote worksite removes from the remote worksite computer 145 at the end of a shift and connects to a card reader in persistent communication with the central computer unit 100. Such persistent communication may be provided, for example, through an access point in communication with the network 120, which is set forth in more detail below.

Embodiments of a distributed mine management system according to the invention include one or more mobile hotspots 140. Mobile hotspots 140 are mobile computers that are capable of wireless data communication with computers located at remote work sites and with a central computer unit 100. In certain embodiments, mobile hotspots 140 are capable of receiving data wirelessly from a remote worksite computer 145, storing that data, and uploading the data to a central computer unit 100 at a later time when the mobile hotspot 140 has established a data connection with the central computer 100. Mobile hotspots also optionally receive information updates from the central computer 100, store the information updates, and forward the information updates to the remote worksite computer 145 when communication between the mobile hotspot 140 and the remote worksite computer 145 is established. In some embodiments, mobile hotspots provide an intermittent communication path 150 between remote worksite computer 145 and central computer 100. In this way, the mobile hotspot 140 provides periodic synchronization between remote worksite computer 145 and central computer 100.

The mobile hotspot 140 includes a mobile hotspot computer, not shown, and a mobile hotspot wireless data transceiver, not shown, that enable communication between the mobile hotspot computer and the remote worksite computer 145 and between the mobile hotspot computer and the central computer unit 100. Distributed mine management systems according to the invention include an intermittent communication path 155 between the mobile hotspot 140 and central computer 100. Intermittent communication path 155 may be realized by intermittent wireless communication between the mobile hotspot 140 and the wireless mine network when the mobile hotspot is in range of a wireless transceiver connected to the mine network. Mobile hotspot 140 may be implemented on a vehicle operated by a mine supervisor who travels a circuit of remote worksites to relay information to and from the networked mine site.

The central computer 100 is in communication with a computer network 127. The computer network 127 can be a wired or wireless local, wide or global area network, such as the Internet. The computer network 127 provides a plurality of access points through which a plurality of connected computing devices, for example, desktop computers 125, laptop computers 130 and personal digital assistants 135, communicate with the central computer unit 100. In a mine management environment, the connected computing devices 125, 130, 135 are optionally associated with mine management functions that occur at relatively static locations. For example, the connected computing devices can be associated with a maintenance shop that receives data from the central computing unit 100 about the condition of mobile equipment. Such data about the condition of mobile equipment can be collected at a plurality of mobile computers 110 that forward or store then forward such data to the central computer 100. Other examples of tasks associated with connecting computing devices 125, 130, 135 include on-site supervisory access to mine management applications running on the central computing unit 100, and remote access via the World Wide Web to mine management applications running on the central computing unit 100.

The mine management system depicted in FIG. 1 can be used to increase the efficient movement of mined material, waste, and equipment in a mine environment by tracking, on a continual basis, the location, velocity and status of all trucks, shovels and other equipment in the mine, and by making optimal work assignments and defining optimal routing paths. Mines that are organized according to a mine management system according to the present invention experience significant improvements in productivity, less equipment downtime and cost savings.

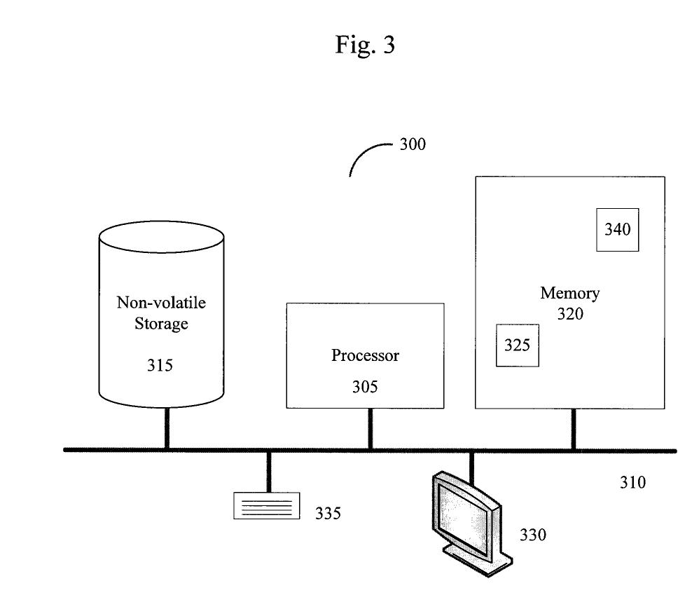

Referring to FIG. 2, a mine management system 200 includes a central computer 205 that communicates with one or more mobile computers 230 over a network 227. The mobile computers 230 are located on pieces of mobile mine equipment, for example, mining trucks. In one embodiment, network 227 is a wireless network, and wireless communication between the central computer 205 and the mobile computers 230 through the wireless network 227 occurs through a plurality of wireless communication interfaces, not shown, that are located with the central computer 205, the mobile computers 230 and/or at various fixed or mobile locations throughout the mine site. The wireless communication interfaces can include any of the wireless communication interfaces compatible with any of the IEEE 802.11 standards. The central computer 205 includes one or more general purposes computers, such as the general purpose computers that are described herein with respect to FIG. 3.

Central computer 205 includes a mine control unit 210, a central database server 220, a central database 215, and/or a messaging and database replication server 225. The mine control unit 210 controls the operation of the mine management system 200, in whole or in part. The mine control unit 210 controls the operation of the mine management system 200 by housing software and running software processes that direct mine operations, for example, by assigning trucks to certain locations in the mine in accordance with optimization routines.

The central database server 220 includes control logic that manages read and write access to a central database 215. The central database server 220 also governs distribution of data stored in the central database 215, for example, to mobile computers 230. The central database 215 stores at least some information useful to the management of a mine. For example, the central database 215 may store geographic information regarding physical topography and layout of the mine, information regarding the acceptable routes of travel available in the mine for various vehicles, data about routes of travel in the mine such as grades, the location of hazards, and the presence of other conditions, information regarding the position and velocity of vehicles in the mine, information regarding the status or health of vehicles and/or other pieces of equipment, for example, the position of a truck bed, the amount of time a vehicle has been in use, or vehicle tire pressure, areas of the mine that are designated for material removal and material waste piles, data indicating the need for a particular vehicle at a particular location in the mine, such as data indicating that a particular shovel has material to load onto a truck, and information regarding vehicle or equipment operators, such as when individual operators came on-shift. Information regarding mine management may be stored in tables in the central database 215. Tables containing information regarding the condition of the mine may contain historical data, or can be continuously updated with new information in real time. Information regarding the condition of the mine may be input into the central database 215 directly from operators relying, for example, on Geographical Information Systems and/or map data, and/or can include information collected by and forwarded from mobile computers 230 on vehicles in the mine.

In one embodiment the central database 215 is an SQL database and the central database server 220 is an SQL database server. Any database structure and database management protocol that is based on SQL or any other relational database protocol are within the scope of the invention. In one embodiment, the central database 215 is implemented using PostgreSQL, however other database management systems are acceptable, for example, MySQL, Oracle, SQL Server and/or Microsoft SQL.

The central computer 205 includes a messaging and database replication server 225. The messaging and database replication server is in communication with the mine control unit 210 and the central database 215 through the central database server 220. The messaging and database replication server 225 copies portions of the central database for forwarding to mobile computers 230 located on mobile mine equipment. The messaging and database replication server 225 also optionally manages the communication of messages to mobile computers 230 located on mobile mine equipment. The messaging and database replication server 225 also optionally manages communications from mobile computers 230 for updating the central database 215. Examples of information passed to mobile computers 230 through the messaging and database replication server 225 include geographical mine layout data, acceptable routes available to mobile equipment through the mine, and task assignments for mobile equipment such as the next shovel to which a truck should report in order to receive a load of material. The messaging and database replication server 225 can also pass customized messages to operators of mobile equipment that are generated by a human dispatcher in communication with the mine control unit 210. Examples of information communicated from mobile equipment to the messaging and database replication server include the position and velocity of a piece of mobile equipment and the status of a piece of mobile equipment, for example, whether a truck is full or whether a truck is available to receive a load of material.

In addition to passing information such as task assignments from the central database 215 to the mobile computers 230, mine control unit 210 can pass raw data to a mobile control unit 240 to calculate a task assignment on its own. Data that would allow mobile control unit 240 to calculate task assignment include, for example: the position and velocity of all trucks in the mine, the status of all trucks in the mine (e.g., whether they are full or empty, waiting at a shovel to be loaded, their load capacities, and whether they have already been assigned to a shovel), the position and status of all shovels in the time, and the expected travel time along defined routes between all the trucks in the mine and all points where trucks might be needed such as shovels or dump sites. Additionally or alternatively, mobile control unit 240 can calculate the predicted arrival time of its associated mobile equipment at a particular destination on the basis of information collected by the mobile computer 230 and copied from the central database 215.

The central computer 205 communicates with the mobile computers through a network 227. In some embodiments the network 227 is a wireless network with data transmitted and received according to any of the IEEE 802.11 standards. Additionally or alternatively the network 227 includes wired communications, intermittent communications through, for example, the intermittent connection of non-volatile storage devices with the network and/or wireless communications using any radio frequency, or optical methods of transmitting and receiving data signals. In the case of a mining environment the network 227 is often implemented as a patchwork of multiple data transfer technologies with different areas of the network having different performance characteristics. For example, in some mine environment embodiments, most of the mine will be covered by a modern IEEE 802.11 network operating at data rates well in excess of 10 Mbit/s. Other areas of the mine may be operating with earlier generation, slower UHF networks. Still other areas of the mine, for example, underground work areas, may not be well suited at all for RF wireless data transmission and may rely on optical or other technologies.

Mobile computer 230 includes a graphical user interface (“GUI”) 265 for presenting data to and receiving input from a mobile equipment operator. Mobile computer 230 also includes a vehicle monitoring module 270. The vehicle monitoring module 270 collects data from a variety of on-board sensors that monitor the status of the piece of mobile equipment. For example, in the case where the piece of mobile equipment is a truck, the vehicle monitoring module 270 can collect data related to tire pressure, oil pressure, oil and water temperature, water levels, position and velocity data from GPS, status information on the position of the truck bed, engine performance parameters such as revolutions per minute, and information from other on-board sensors such as cameras, inertial sensors and proximity detectors.

Mobile computer 230 includes a messaging and database replication client 260. The messaging and database replication client 260 is in communication with the messaging and database replication server 225 through the network 227. The messaging and database replication client 260 sends data updates, for example the current position and velocity of a piece of mobile equipment, to the messaging and database replication server to be saved in the central database 215. The message and database replication client 260 also receives replication updates from the messaging and database replication server 225, for example, the location of a new or modified travel route in the mine, or the identification of a shovel that needs a truck on which to load material.

Mobile computer 230 includes a mobile control unit 240, a mobile device data collection and analysis unit 245 and object/relational mapping software 250. The mobile control unit 240 and mobile device data collection and analysis unit 245 interface with the on-board GPS 235 and the vehicle monitoring module 270. The mobile device data collection an analysis unit 245 tracks the current activity and status of the piece of mobile equipment. The mobile device data and analysis unit 245 includes control logic that interfaces with a mobile database 255 to store and/or compute information regarding the production cycle, for example, by analyzing historical data regarding the route of travel taken by the piece of mobile equipment and historical data regarding whether the piece of mobile equipment has received or dumped a load of material. The mobile device data collection and analysis unit 245 periodically or continuously calculates a piece of mobile equipment's arrival time at a destination on the basis of route data received, for example, from the mine control unit 210, as well as speed and position data received, for example, from the GPS 235 or other on-board sensors. The calculated arrival time is periodically uploaded to the central computer 205 over the network 227. Alternatively or additionally, the arrival time of a piece of mobile equipment at a location in the mine, for example at a shovel, is calculated centrally by the mine control unit 210 on the basis of position and velocity information from the mobile computer 230 and mine layout and route information stored in the central database 215. The mobile control unit 240 optionally includes object/relational mapping software 250 to map one or more relational database tables to an object model used by the mobile equipment data collection and analysis unit 245. Object/relational mapping software 250 maintains referential integrity in the mobile database 255.

The replication of portions of the central database 215 onto the mobile database 255 enables the continued efficient operation of mobile equipment in the event that mobile computer 230 loses network communication with central computer 205. In the event of a loss of communication, the operator of the mobile equipment will still have local access to the mine layout and the next assignment, that is, the next destination where the truck is needed.

Mobile computer 230 includes a mobile database 255. In some embodiments the mobile database 255 is a referential SQL database organized according to SQL software such as Microsoft SQL Mobile or SQL compact. In other embodiments the mobile database 255 is a non-relational database. The mobile database 255 can be any device capable of storing organized data in whatever form. An operator of the mobile device 230 uses the GUI 265 to interact with the mobile equipment control unit 240, to perform queries on the mobile database 255, and/or to receive database update notifications.

Mobile computer 230 includes a peer-to-peer communications module 275. Peer-to-peer communications module 275 enables data communications between mobile computer 230 and additional mobile computers located on mobile equipment throughout the mine environment. Peer-to-peer communication between mobile computers enable sharing of position, velocity and status information between mobile computers. In the event that mobile computer 230 loses connection with the central computer 205, mobile control unit 240 updates the mobile database with information about the status of other pieces of mobile equipment with information received over the peer-to-peer communications module 275. Mobile control unit also uses information received from other vehicles over the peer-to-peer communications module 275 to determine whether the vehicle associated with mobile computer 230 comes too close to another vehicle. In other embodiments, mobile control unit 240 determines proximity hazards on the basis of position information about its own and other vehicles received from the central computer 205.

The mobile computer 230 can perform important data analysis functions on-board the mobile vehicle. For example, in the case of a mining truck, the mobile computer can determine when the truck has performed one production cycle. A production cycle is defined as a completed task executed by the truck. For example, a production cycle might be defined by the act of receiving a load of mine material at a shovel, transporting that material to a crusher, and dumping the mine material near the crusher for further processing. A production cycle might also be defined by the act of picking up a load of waste material, transporting that waste material to a dump site, and dumping the waste material at the dump site. A variety of on-board sensors in communication with the vehicle monitoring module 270 collect data related to the state of the vehicle in the production cycle. For example, the vehicle monitoring module 270 can detect the position of the truck bed, either directly or by monitoring the position of the tray position switch in the truck. The vehicle monitoring module 270 can determine the amount of weight currently being carried by the truck by reading on-board weigh system information or tire pressure. Status information about the state of the truck, for example, whether it is full or empty, can be entered directly by the vehicle operator through the GUI 265. On board information related to the vehicle's position, heading and speed is also relevant to determining the state of the vehicle in the production cycle. Such information includes time varying historical GPS position data, and/or velocity data obtained from GPS and/or other on-board sensors.

Mobile device data collection and analysis unit 245 classifies data collected on-board the mobile vehicle according to the data's importance to the efficient operation of the mine. High priority data includes data regarding the current position, velocity and production status of the vehicle. In the case of a mining truck, production status means at least whether the vehicle is empty or full. Medium priority data includes data regarding the number of times a vehicle has recently undergone loading or unloading. Low priority data includes other data collected on board about the status of the vehicle, for example, engine operating parameters, coolant temperature or tire pressures. When the mobile control unit 240 stores data collected on-board the piece of mobile equipment in the mobile database 255, it includes information relating to the priority classification of the data. In the event that mobile computer 230 loses then reestablishes communication with central computer 205, high priority data is sent to the central computer 205 by the message and database replication client first, followed by medium priority data, followed by low priority data. Moreover, in the event that the piece of mobile equipment is in a low-bandwidth region of the network 227 where communication speeds are limited, updates for high priority data occur first. In this way, mine control systems according to the invention ensure that scarce network resources are allocated first for the movement of data most useful for maintaining efficient production.

Providing a mobile control 240, mobile database 255, GPS 235, GUI 265 and other modules or units that make up the mobile computer 230 allows for the continued efficient operation of mobile equipment independent of a persistent connection with central computer 205. In the event that mobile computer 230 loses communication with central computer 205, mobile computer 230 can still provide routing information, for example, the next destination of the truck, to the operator by relying on recent updates that have been saved to mobile database 255.

FIG. 3 shows a block diagram of a general purpose computer 300 according to an embodiment of the invention. One or more general purpose computers 300 are used to implement the central computer 100 of the mine production system described with reference to FIG. 1. General purpose computer 300 includes one or more processors 305, memory 320, non-volatile storage 315 such as a disk drive, array of disk drives, or database, and input/output devices such as a monitor 330 and a keyboard 335. General purpose computer 300 also optionally includes one or more peripheral devices, not shown. Processor 305, non-volatile storage 315, memory 320 and input/output devices communicate with one another over a local interface 310. In one embodiment, the local interface 310 is a multi-wire bus. The local interface 310 optionally includes additional elements that are known in the art but not shown, for example, controllers, buffers, drivers and other communications hardware such as repeaters or wireless transceivers. Additionally, the local interface 310 includes address, control and other connections to support data communication as necessary among connected components.

The processor 305 is a hardware device for performing mathematical calculations necessary for implementing software processes, particularly, software processes stored in memory 320. The processor 305 is optionally a commercially available microprocessor including a central processing unit and/or arithmetic logic unit, an array of processors, or any other device capable of executing software instructions.

The memory 320 includes any one or combination of volatile memory elements such as random access memory. The memory 320 can also optionally include non-volatile memory elements such as hard disk drives, magnetic and/or optical storage media, and/or non-volatile solid-state storage such as flash memory. Memory 320 can be physically distributed remotely from processor 305 so long as it is accessible by the processor 305.

Memory 305 includes software 325. The software 325 in memory 305 includes one or more programs that include executable instructions for the processor 305. For example, software 325 may be a program for implementing the mine control unit 210 described above with respect to FIG. 2.

The memory 305 optionally further includes an operating system 340 known in the art operable to control the execution of computer programs, for example, the mine control unit 210 described above with respect to FIG. 2. The operating system 340 also manages data flow to the processor 305, provides scheduling, input-output control, file management, communication control and related services for the general purpose computer 300.

Software 325 may be any set of machine readable, machine executable instructions including, for example, an executable file or script. In the event that the software 325 is an executable file, the software 325 will be the result of compiling and linking source code by means known in the art. The translator, assembler, compiler and/or program libraries necessary for converting source code into executable instructions may optionally be included in the memory 320. The source code that forms the basis for software 325 may be written in an object oriented programming language, which is characterized by the interaction of programming objects such as predefined classes of functions and predefined data sets, or a procedure oriented programming language, which is characterized by routines, subroutines, procedures and functions. Examples of acceptable programming languages for generating source code include C, C+, C++, C-sharp, Pascal, Fortran, Visual Basic, Perl, Java and Ada. The messaging and database replication server 225 and other functions included in or used by the mine control unit 210 described above with reference to FIG. 2 may be written in objective-C and/or pure Java to assure the ability to implement the central mine control functions under any operating system running on the general purpose computer 300.

General purpose computer 300 includes input/output devices, for example keyboard 335 and monitor 330. General purpose computer 300 may optionally include additional input/output devices not shown, for example, microphones, printers, scanners, touch screens, additional visual displays, speakers, mice and joysticks. The general purpose computer 300 may optionally include other peripheral devices that simultaneously provide input/output functions, for example, modems, optical and/or RF transceivers, routers, bridges, gateways and switches.

If the general purpose computer 300 is a PC, workstation, or the like, the software 340 in memory 320 may include a basic input output system (BIOS) (not shown). The BIOS is a set of fundamental software routines that are automatically executed on startup to initialize and test hardware such as the processor 305.

When the general purpose computer 300 is in operation, the processor 305 is configured to execute software 340 stored in memory 320, to write data to and read data from memory 320, and to generally direct the operation of the general purpose computer 300 in accordance with the instructions encoded in software 340.

Using time varying position information derived from GPS sensors on-board mobile equipment, a mining truck allocation algorithm stored in software being run on a central computer and/or on mobile computers, calculates optimal truck assignments to minimize truck travel time, truck wait time, and shovel wait time. Truck assignment optimization algorithms are known in the art. One acceptable method of performing truck assignment is explained in “Computer Dispatch Aids Mine Productivity”, White, Olson and Vohnout, Australian Journal of Mining, July, 1991, which is incorporated by reference herein in its entirety.

Mine control systems according to the invention rely on a variety of raw data to determine optimal truck assignment. Examples of raw data used in optimization routines according the invention include: haulage routes in a mine including the locations of shovels and dumps, the distances between those locations, the elevations and/or grades along those routes, the travel times between shovels, dumps and intermediate signposts, the amount of time required to load a truck at a shovel and/or to dump a load at a dumping site, such as a waste dump or crusher, material grade information, i.e., information regarding the composition of material at a shovel and the required blending targets at material dumps, operational status of trucks and shovels, and miscellaneous mining constraints such as shovel priorities, dump capacities, truck capacities, and scheduled operator breaks.

Efficient operation of a mine site requires rapid, real-time determination of optimal truck assignment. In order to accomplish this, systems according to the invention employ a sequential algorithm divided into three main steps. First, systems according to embodiments of the invention determine the Best Path (BP) between all two points of significance in the mine, next, systems according to the invention apply Linear Programming (LP) for each significant change in time dependant variables to determine the required flow rates of material between points, and finally, systems according to embodiments of the invention apply Dynamic Programming (DP) to assign trucks to shovels in real time. The BP system generates the shortest paths between all pairs of locations in the mine road network. The LP system takes travel times and optimal routing from the BP system, as well as information concerning the current status of equipment in the mine such as the number of ready shovels and trucks, loading and dumping intervals at shovels and dumps, blending requirements at crushers, and shovel priorities to generate optimal material flow rates between points in the mine network. Solutions to the LP algorithm set forth in additional detail below generate the optimal path flow rates in terms of material volume per unit time to determine haulage requirements for a given status condition of a mine. Finally, the DP system uses these optimal path flow rates, a list of trucks needing an assignment from a dump to a shovel, and the current travel times and distances to produce an optimal list of paths from dumps to shovels ordered by need and assigns trucks to paths.

The determination of Best Paths can be made according any path algorithm known in the art to determine the paths of minimum travel time throughout the mine haul road network. The BP algorithm starts with a definition of the mine topology, including locations, elevations roads and distances. In certain embodiments, the mine topology is defined in a Geographical Information System (GIS) database, which can be edited manually or automatically through sensor input, for example, input by GPS receivers located on pieces of mobile mine equipment. Locations in the mine topology are defined by coordinates, and new locations can be added by entering the coordinates of the location and the distance to the nearest pre-defined location in the network. When a user modifies the road network database, the system executing the BP algorithm computes a directed tree data structure for each location in the mine, where each directed tree data structure describes the minimum travel-time path from that location to every other location in the network.

Initially, systems executing the BP algorithm use a travel time correlation function to translate haul grades (i.e., the slopes of roads) and distances into travel times between locations. As trucks travel along the mine haul road network, actual travel times between locations along haul roads are measured. Optionally or alternatively systems executing the BP algorithm maintain a moving average of actual measured travel time along segments of the haul road network. Systems executing the BP algorithm generate the following data for subsequent optimization routines: total minimum distance for each haul, estimated travel time for each haul, and intermediate locations and waypoints the trucks on any given haul should pass.

Once the road haul network has been defined according the BP algorithm, the Linear Programming (LP) system generates a matrix defining the minimum required flow rates for material along haulage routes in the mine in terms of units of material per unit time. The minimum required flow rates are the flow rates that minimize the total trucks required to cover the operating shovels. Minimum required flow rates are calculated on the basis of average travel along routes subject to the following additional constraints: continuity at each shovel and dump, maximum digging rate at each shovel, maximum capacity at limited dumps, total available trucks, material grade blending limits, and material category blending targets. Systems according to embodiments of the invention use LP algorithms to provide information required to make optimal truck assignments in real time.

The LP algorithm yields a solution in terms of path flow rates in terms of volume of material per unit time along paths in a mine road network. Systems according to embodiments of the invention then employ a Dynamic Programming (DP) model to solve the problem of how to assign trucks to haulage paths in order to achieve the desired flow rates. In the simplest case, as each truck becomes available for a new assignment, a scan is made for the neediest shovel, and the available truck is assigned to that shovel. This simple solution may be suboptimal, however, particularly if the available truck is far from the neediest shovel. An efficient truck allocation algorithm must take into account the impact a given truck assignment will have on future truck assignments as well as intelligence about other trucks that are likely to be available for assignment. One method to balance these concerns is to implement an optimization routine in accordance with Bellman's Principle of Optimality, which states: “[a]n optimal policy has the property that, whatever the initial state and initial decision, the remaining decisions must constitute an optimal policy with regard to the state resulting from the first decision.”

Rather than simply matching the first available truck to the neediest shovel, systems according to embodiments of the invention match the best trucks to the neediest shovels whenever any truck requests a truck assignment. In this process, systems according to embodiments of the invention create lists of paths generated according to the LP algorithm, ordered by need time, and a list of trucks soon to request a shovel assignment, ordered by expected assignment time. The truck list includes all trucks current dumping at a dump, stockpile, or crusher, as well as all trucks currently en route from a shovel to a dump. The path list contains the haulage allocation for each path connected to an operating shovel, the time of last allocation of a truck to that path, and the optimal path haulage rate for that path as determined by the LP algorithms.

The LP-determined paths are ordered according to their need times. The need time is the expected time that the path next requires a truck assignment. If path i feeds shovel j, need time can be approximated by:

NeedTimeᵢ=Lᵢ+(Fᵢ×(Aⱼ−Rⱼ))/Pᵢ

where

Lⱼ is the last time a truck was allocated to shovel j

Fᵢⱼ is the flow rate of path i over the total flow rate into shovel j

Aⱼ is the total haulage allocated by time Lⱼ to shovel j

Rⱼ is haulage requirement of shovel j

Pᵢ is the path flow rate in units of volume per unit time for path i.

The neediest path is the path with the smallest need-time value. When two shovels are currently in need of a truck assignment and they have different priorities, then the path feeding the shovel with the higher priority becomes needier.

When making any truck assignment, systems according to embodiments of the invention choose the first path in the “needy” path list. Systems according to embodiments of the invention then choose the best truck for this needy path. Once the best truck is assigned to the neediest path, that path is moved down the list of needy paths. The next neediest path is then assigned the next best truck, and so on, until all trucks on the assignment list have shovel assignments. This definition of the best truck for the neediest path improves shovel coverage and minimizes truck travel and shovel idle time.

Systems according to embodiments of the invention compute a “lost-tons” function that represents the lost productivity caused by the shovel idle time, truck idle time, and excess truck travel time that result from every truck assignment decision. The lost-tons function can be represented by

$$LostTons = \frac{TruckSize \times TotalRate}{NeededTrucks} \times ( TruckIdle + ExcessTravel ) + ShovelRate \times ShovelIdle$$

where

TruckSize=size of the truck being assigned

TotalRate=total dig rate of all shovels in the mine

NeededTrucks=total required trucks to feed the paths defined by the LP algorithm

TruckIdle=Expected truck idle time for the assignment under consideration

ExcessTravel=Extra empty travel time to the neediest path

ShovelRate=Sum of all path rates into the neediest shovel

ShovelIdle=Expected shovel idle time for the assignment under consideration.

For trucks the lost-tons function computes the lost production due to extra empty travel time, while for shovels, it adds the lost production to shovel idle time. Thus, an optimal assignment method defines the best truck for the neediest path as that truck which has the minimum lost tons function.

Ideally, the lost-tons function would be evaluated for every available truck assignment for every available path. This sort of comprehensive optimization may tax computer resources and cause delay in truck assignments, which would be inefficient. Systems operating according to embodiments of the invention constrain the optimal solution set by preferentially assigning trucks to needy, under-trucked paths before needy over-trucked paths. An over-trucked path is a path that currently has enough trucks assigned to it to accommodate the haulage requirements defined according to the LP algorithm. A needy path is considered under-trucked as long as the haulage allocated to it does not exceeded the haulage requirements of the shovel associated with the path. An exemplary algorithm that favors needy under-trucked paths is:

Repeat

if (neediest path is under-trucked) allocate the best truck to the neediest path

else

allocate the earliest truck to its best path

until (all trucks are assigned).

Best path is defined as the one that minimizes the lost-tons function subject to the capacity and blending requirement imposed by the dump and shovel with which the path is associated. Shovel that are not feeding constrained dumps are favored. A dump is constrained when it has blending requirements or when its target feed rate is larger than its capacity.

Other methods for truck assignment optimization are acceptable. For example, systems according to embodiments of the invention may compute a set of optimal truck assignments that minimize excess truck travel time, truck waiting time and shovel idle time. An exemplary algorithm for accomplishing this optimization considers the following variables:

N(t) The total number of trucks being allocated.

N(l) The total number of loading units being allocated.

T(i) The travel time for the i'th LP selected path.

F(i) The target feed rate for the i'th LP selected path.

R(i) The current moving average feed rate allocated to the i'th LP selected path.

S(j) The j'th assignment set of truck allocations to paths feeding loading units.

T(j) The excess travel time incurred by all trucks in the j'th assignment set.

X(T) Relative cost weighting factor for excess travel time.

W(j) The total truck waiting time incurred by all trucks in the j'th assignment set.

X(W) Relative cost weighting factor for truck waiting time.

I(j) The total loading unit idle time incurred by all shovels in the j'th assignment set.

X(I) Relative cost weighting factor for loading unit idle time.

C(j) Cost function of S(j), evaluated as X(T)*T(j)+X(W)*W(j)+X(I)*I(j).

As in the methods set forth above, each discrete truck assignment affects a truck waiting time W(j) and loading unit idle time I(j) for all other assignments. The assignments of the individual trucks can be coordinated to improve efficiency. The total T(j), W(j), and I(j) for each assignment set S(j) may be evaluated and compared.

Because the total number of possible assignment sets is N(1)**N(t), performing an exhaustive search of all possible assignment sets may be undesirable. For example, a typical mining operation could have 10 or more loading units and 50 or more trucks, making the total number of possible assignments 10⁵⁰. It may also be undesirable to investigate all possible assignment sets because a goal of the discrete assignment algorithm is to minimizes waiting, idle, and travel times for a given assignment set and vetting 10⁵⁰ possible assignments could generate additional delays. This algorithm may be constructed to avoid all the blending, digging rate, dumping capacity, and other constraints already optimized in the LP optimization algorithm. Thus, the assignment algorithm may be constrained to only investigate those assignment sets which closely match an optimal LP selected feed rates F(i), which greatly decreases the dimensionality of the search.

The truck assignment algorithm consists of the following steps: creating an assignment set S which includes an ordered queue of all mobile equipment 104 currently assigned to each loading unit; finding the neediest path P(j) which minimizes T(i)*(R(i)-F(i)); evaluating C(j) for allocating each unallocated truck, A(j) to path, P(j); and for the smallest N values of C(j), allocating truck A(j) to the assignment set S(j) and repeat the algorithm at step 2.

The algorithm may continue until the assignment set with minimum cost C(j) is found. Note that the dimensionality of this algorithm increases proportional to N², where N is the number of potential assignments evaluated for each truck. In practice, small values of N (eg. N=2 to N=4) yield optimal results, since higher values of cost C(j) are increasingly unlikely to yield optimal values for the assignment set S(j).

Still other assignment algorithms are acceptable. Any truck assignment algorithm that makes truck assignments as a function of a path need time function and a lost tons function are deemed to within the scope of the invention. Systems, for example, computers running software processes for implementing optimization algorithms according to embodiments of the invention may be physically located anywhere in a networked mine environment. For example, truck assignments may be made centrally, by a central mine control unit and communicated to trucks over a wireless network. Alternatively or additionally, data for calculating truck assignments may be passed to mobile computers located on trucks, which mobile computers then compute optimal truck assignments themselves.

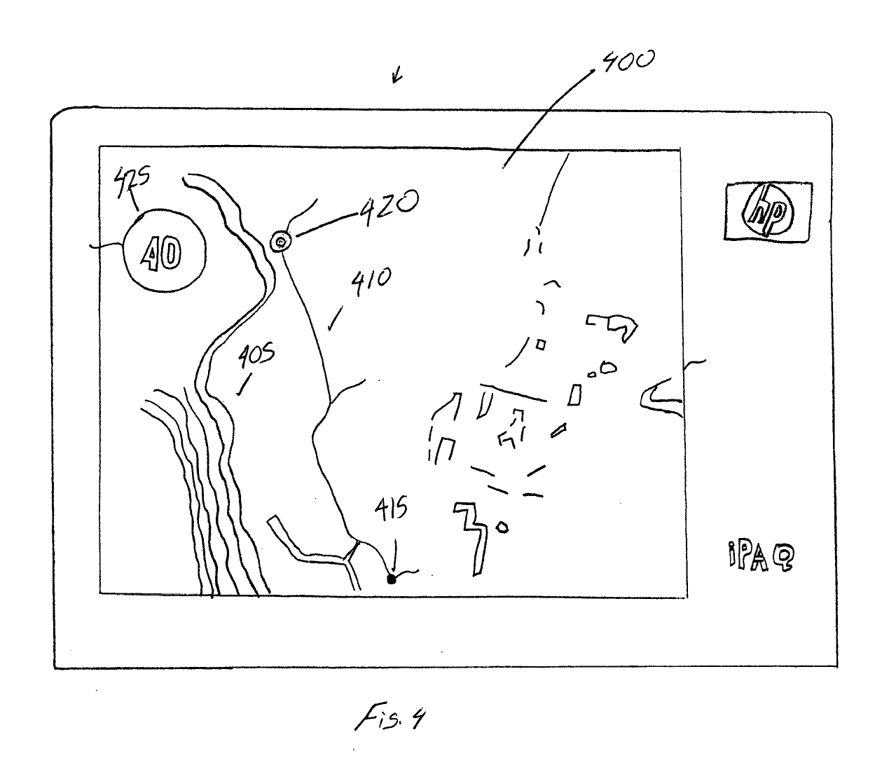

FIG. 4 shows a graphical user interface (“GUI”) display according to an embodiment of the invention. GUI display 400 includes an overhead depiction of a mine environment. GUI display 400 includes representations of physical features corresponding to mine topography 405, acceptable routes of travel in the mine 410, an indication of the time-varying position of the piece of mobile equipment 415 associated with the mobile computer generating the GUI, and the destination 420 that has been assigned to the mobile equipment 415. GUI display 400 also optionally includes information relevant to the operator of the piece of mobile equipment as the equipment moves along the assigned route of travel. For example, GUI 400 display can provide alerts of hazards, speed limit indicators 425 or other route specific messages.

The invention has been described with reference to certain specific embodiments. Those skilled in the art of mine management and distributed computing systems generally may develop other embodiments of the present invention. The terms and expressions that have been used to describe certain embodiments in the foregoing specification are terms of description, rather than limitation, and, in using such terms, there is no intention to exclude equivalents of the features shown and described. The scope of the invention is defined only by the claims that follow.

What is claimed is:

1. A distributed mine management system comprising:
at least one piece of mobile equipment;
a central computer having a central database controlled by a mine control unit;
at least one mobile computer in communication with the mobile equipment, the mobile computer having a mobile database controlled by a mobile control unit;
at least one wireless communication device enabling communication between said mine control unit and said mobile control unit, wherein said mobile computer unit is operable independent of the mine control unit; and
a remote worksite computer having an intermittent data communication path with said central computer.

2. The system of claim 1, wherein said intermittent data communication path includes a mobile hotspot.

3. A method for managing the movement of equipment at a mine site, said method comprising:
tracking information regarding a status of a mobile equipment with a mobile computer joined to the mobile equipment;
storing information regarding the status of the mobile equipment on the mobile computer joined to the mobile equipment, where storing information regarding the status of the mobile equipment on the mobile computer joined to the mobile equipment comprises identifying high, medium and low priority data regarding the status of the mobile equipment and storing high, medium and low priority information regarding the status of the mobile equipment;
transmitting information regarding the status of the mobile equipment from the mobile computer joined to the mobile equipment to a central computer;
receiving instruction from the central computer at the mobile computer;
interrupting communication between the central computer unit and the mobile computer unit; and
directing the mobile equipment to act with the mobile computer based on the received instruction while communication is interrupted.

4. The method of claim 3, further comprising synchronizing a plurality of data stored in the mobile computer unit with a plurality of data stored in the central computer wherein high priority information regarding the status of the mobile equipment is synchronized first, followed by medium priority information regarding the status of the mobile equipment, followed by low priority information regarding the status of mobile equipment.

5. A computer program product embodied in a computer readable medium, said computer program product being useable with a programmable computer processor to track mobile equipment at a site, said computer program product comprising a series of computer readable program steps to effect:
tracking information regarding a status of the mobile equipment with a mobile computer in communication with the mobile equipment;
storing information regarding the status of the mobile equipment on the mobile computer joined to the mobile equipment, where storing information regarding the status of the mobile equipment on the mobile computer joined to the mobile equipment comprises identifying high, medium and low priority data regarding the status of the mobile equipment and storing high, medium and low priority information regarding the status of the mobile equipment;
transmitting information regarding the status of the mobile equipment from the mobile computer in communication with the mobile equipment to a central computer;
receiving instruction from the central computer at the mobile computer;
interrupting communication between the central computer and the mobile computer; and
directing the mobile equipment to act with the mobile computer based on the received instruction while communication is interrupted.

6. The computer program product of claim 5, further comprising the program step of synchronize a plurality of data stored in the mobile computer unit with a plurality of data stored in the central computer wherein high priority information regarding the status of the mobile equipment is synchronized first, followed by medium priority information regarding the status of the mobile equipment, followed by low priority information regarding the status of mobile equipment.
